(19) United States
(12) Patent Application Publication
(10) Pub. No.: US 2010/0136949 A1
(43) Pub. Date: Jun. 3, 2010

(54) METHOD OF PROVIDING SECURE, CONFIDENTIAL, CONTACT BETWEEN INDIVIDUALS, AND FOR THUS PROTECTING THE ASSETS AND PROPERTY OF THE INDIVIDUALS

(76) Inventors: Robert S. Bira, Fenton, MO (US); Kevin S. Dill, Lee's Summit, MO (US)

Correspondence Address: SPENCER, FANE, BRITT & BROWNE, 1000 WALNUT STREET, SUITE 1400, KANSAS CITY, MO, 64106-2140, US

(21) Appl. No.: 12/625,360

(22) Filed: Nov. 24, 2009

Related U.S. Application Data
(60) Provisional application No. 61/118,275, filed on Nov. 26, 2008.

(51) Int. Cl. H04M 1/66

(52) U.S. Cl. 455/410

(57) ABSTRACT

The present invention provides a method for providing secure communication between individuals. The method includes the steps of a provider, assigning to a subscriber a unique identifier, providing the subscriber at least one tag having the unique identifier and contact information for a provider indicated thereon, receiving a communication from a third-party wishing to contact the subscriber, and transmitting the third-party's message to the subscriber associated with the unique identifier.

### CROSS-REFERENCE TO RELATED APPLICATIONS

This application claims priority to U.S. Provisional Patent Application No. 61/118,275, filed Nov. 26, 2008 and incorporated by reference herein in its entirety.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### BACKGROUND OF THE INVENTION

As of this writing, the total number of mobile phone subscriptions in the world exceeds 3.3 billion—half of the human population of earth. Because of the pervasive nature of mobile technology, people are accustomed to being connected wherever they are. Cellular phone numbers are not typically published, however, and this makes it difficult to contact a cellular phone user when necessary or desirable if one does not already have that person's cellular phone number. Publishing cellular phone numbers is not a desirable solution to the problem because of the prevalence of telemarketing and other unwanted calls that may be received by the owner of a publicly-available cellular phone number.

The need to contact a cellular phone user nevertheless remains. In some situations, such as an emergency, returning lost property, contacting an individual during a natural disaster or terrorist attack, and the like, contacting an individual view cellular phone even though their cellular phone number is not known could be invaluable.

What is needed, therefore, is a secure, confidential method of contacting an individual via their cellular phone, while at the same time preserving that individual's contact information from the public and others who have not received it directly from the cellular phone user.

### SUMMARY OF THE INVENTION

The present invention provides a method for providing secure communication between individuals. The method includes the steps of a provider, assigning to a subscriber a unique identifier, providing the subscriber at least one tag having the unique identifier and contact information for a provider indicated thereon, receiving a communication from a third-party wishing to contact the subscriber, and transmitting the third-party's message to the subscriber associated with the unique identifier.

According to another aspect of the invention, the communication received from the third party is an e-mail message, telephone call, cellular phone call, text message, or instant message.

According to still another aspect of the invention, the tag is a plastic card, key chain, decal, dog tag, wristband, RFID tag, clothing label, luggage tag, backpack tag, golf-themed tag, ski equipment tag, or house sticker.

In still another aspect of the invention, a method is provided for protecting a child's identity while allowing for secure communication between the child or a guardian of the child and a third party. The method includes assigning a unique identifier to the child, providing the child with at least one tag having the unique identifier and contact information for the provider, receiving a communication from a third party that pertains to the unique identifier assigned to the child, and transmitting the communication to child or a guardian of the child.

Another aspect of the invention provides a kit having a plurality of tags included therein, the tags including a unique identifier assigned to a user of the kit. The tags further include contact information for a provider of the present invention. A third party wishing to communicate with the user uses the contact information provided on the tag to contact the provider, and relays to the provider the user's unique identifier and the message for the user. The kit may also include instructions for a user who wishing to subscribe to one or more of the provider's services.

### BRIEF DESCRIPTION OF THE DRAWINGS

FIG. 1 is a schematic diagram providing exemplary features of the present invention.

FIG. 2 is a schematic diagram of one implementation of a web site providing one implementation of the present invention.

### DETAILED DESCRIPTION OF THE INVENTION

The present invention provides a secure, confidential method of contacting an individual via their cellular phone or other chosen method of communication, while at the same time preserving that individual's contact information from the public and others who have not received it directly from the individual. The following description sets forth various aspects of the invention, though it is intended that the following be understood as illustrative of the general principles of the present invention, rather than limiting thereof.

Users of the present invention are preferably typically subscribers to a service offering the advantages of the present invention. The person or persons implementing the principles of the present invention and making the present invention available to subscribers also “use” the invention in ways described below, however the word “user” as used herein will generally indicate a subscriber to a business, web site, or other entity implementing the present invention. When the word “user” is used to indicate third-party users for the purposes of contacting a subscriber or subscribing to a provider of the present method, such usage will be apparent from the context in which the word is used. An individual, business, or other entity providing or implementing the present invention is typically referred to herein as a “service provider” or simply a “provider.”

A subscriber to a web site, business service, or other service provider providing the present invention receives a number of tags having contact information for the provider, as well as a unique identifier (i.e. a Member ID) corresponding to the subscriber. These tags do not have any information that allows personal identification of the subscriber, or any contact information for the subscriber. The subscriber then places these tags in desired locations, such as on her person, on personal property, and the like. Suitable tags may include, but are not limited to, plastic cards, key chains or tags adapted for attachment to key chains, window or other decals, dog tags, wristbands, RFID tags, clothing labels, luggage tags, backpack tags, golf-themed tags for golf bags and the like, ski equipment tags, reflective house stickers, and the like. The word “tag,” as used herein, refers generally to each of these and to other suitable items not specifically described herein.

A subscriber to, for example, a web site implementing the present invention will preferably choose a preferred method of receiving communications relating to the function of the present invention. A subscriber may choose to be contacted via voice calls directed to the subscriber's cellular phone, or may instead choose to receive on their cellular phone an SMS message. When an third-party individual needs or desires to contact a subscriber to a provider of the present invention, that individual preferably uses an 800 number to contact the provider implementing the present invention, and that call is then forwarded to the subscriber, or an email, SMS message, or other message is forwarded to the subscriber. Alternatively, information is obtained by a live operator at the 800 number and provided to the subscriber via SMS message, email, or other technology.

The way in which information is received by the present system (such as calls from individuals wishing to convey information to subscribers, or e-mail or text entered into web forms by these individuals) may vary widely in terms of particulars, and such variations will be readily apparent to those of ordinary skill in the art upon reading this disclosure. In one exemplary embodiment, a provider implementing the present invention is contacted by a third-party caller via an 800 number provided on one or more tags a subscriber has placed on items of personal property or in other desired locations. An auto answer feature is preferably provided to welcome the caller to the system and instruct them to dial 911 if the call is related to an emergency. The caller is then placed on hold and in queue to speak to a live operator. The actions of the operator in response to the call may vary depending on whether the subscriber has chosen to receive direct contact from individuals or whether the subscriber has chosen to receive SMS messages or other communications.

In the situation wherein the subscriber has chosen to receive SMS messages, for example, the operator may ask the caller for a short message, which will be forwarded to the subscriber, and also ask whether the caller wishes to provide a call-back number so that the subscriber may contact the caller at the subscriber's discretion. If the caller prefers to remain anonymous, then the message is simply sent to the subscriber via SMS messaging. If the caller wishes to provide a number, that number is forwarded to the subscriber along with the caller's message. It is preferred that the message is also sent via text messaging and e-mailed to the subscriber's e-mail address on file with the provider.

In the situation wherein the subscriber has chosen direct contact, the operator will inform the caller of this fact and then transfer the caller directly to the subscriber's contact number. The contact number of the subscriber is not provided to the caller. The operator preferably remains on the line to introduce the call to the subscriber. If the subscriber is busy or does not answer the phone, the caller may then leave a voice mail message for the subscriber. An e-mail is preferably provided to the subscriber confirming that a call was received relating to that subscriber, and that the call was transferred to the subscriber's phone.

An individual wishing to contact a subscriber of the present invention may, in addition to contacting the subscriber directly or indirectly via an 800 number provided on tags placed by the subscriber, also retrieve information concerning the subscriber from a web site implementing the present invention. In such an embodiment of the present invention, the individual wishing to obtain information about a subscriber simply enters the subscriber's Member ID (a unique identifier assigned to the subscriber when the subscriber enters into a subscription agreement with a provider implementing the present invention) into the appropriate location on the web site, and then receives any information the subscriber has chosen to make available to the public.

In addition to live operator implementations of the present invention, such as described above, the present invention may also be implemented using an interactive voice response system in addition to, or in place of, live operator service. In an exemplary implementation of an interactive voice response system, a caller calling a service provider implementing the present invention may be prompted by the interactive voice response system to enter a Member ID for the member to whom they wish to convey information. The system can then decide the next steps in the process based on the subscription package purchased by the subscriber to whom the call pertains.

In one implementation of the present invention, for example, the caller may be prompted to enter a call-back number to be forwarded to the subscriber. This call-back number can then be forwarded to the subscriber, who can place a call to the original third-party caller in order to receive the information the caller wishes to convey. In an alternative implementation of the invention, the subscriber may call the provider providing the present invention, the provider in turn connecting the subscriber to the original caller so that the subscriber's phone number is not available to the original caller through, for example, caller ID. In either situation, an e-mail may be provided to the subscriber as a way to follow up on the contact and provide a record thereof.

In another implementation of the present invention utilizing an interactive voice response system, the system may connect the caller with the subscriber directly if the subscriber has chosen to allow such direct communication. An announcement may be provided by the system leading in to the transferred call so that the subscriber is immediately aware that the call is coming from the system and concerns the subscriber's property or other interests. In addition, the system may also provide the caller with medical, alternate contact, or other information that the subscriber has indicated should be available to callers to the system. The caller may also choose to contact customer service.

In any of the implementations of the invention described herein, it is contemplated that the provider implementing the present invention may provide voice mail service to a subscriber, the voice mail service being hosted by the service provider and separate from voice mail services the subscriber may already have in conjunction with a cellular or other phone. An SMS message, e-mail, or other message may be generated by the present system in order to notify a subscriber that a voice mail has been received.

In one aspect of the invention, all of the technology components involved, such as voice, web, and e-mail technologies, are built on industry-standard software platforms and run on computers at a secured third-party hosting site. In situations wherein a database and/or web server is shared with other applications, a dedicated partition will be used for information received from or relating to subscribers of the present invention. Disaster recovery plans, as well as maintenance and backup procedures are implemented, and necessary architecture provided, to ensure preservation of data and continuity of service. Providing such disaster recovery, backup and maintenance, and the like, as well as the corresponding architecture, will be well within the skill of one of ordinary skill in the art, upon reading this disclosure.

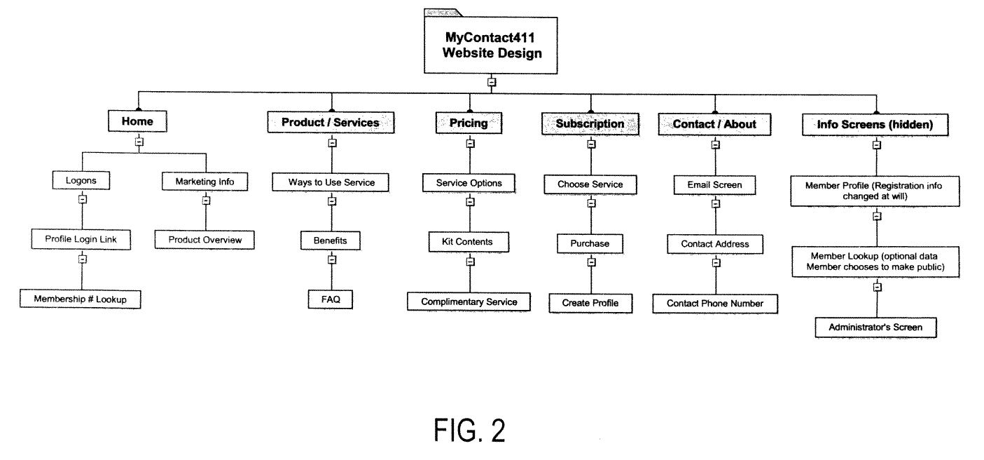

In one aspect of the present invention, a web site is provided for allowing subscribers to access and subscribe to the services of the present invention. Security is assured by using a HTTPS-formatted web site, along with SSL encryption. One exemplary design and structure for a web site implementing aspects of the present invention is shown in FIG. 2. As depicted, the site is divided into four initial pages such as, for example, Home, Products/Services, Pricing, Subscription, and Contact/About. It is again noted that this design and structure is exemplary only and that the method of the present invention could be implemented using any suitable web design and structure.

Continuing with the exemplary web site structure shown in FIG. 2, from the Home page a user of the site may access marketing and product information, and may also log on to the site. Further, a third-party user of the site may also enter a registration code in order to begin the process of communicating information to a subscriber of the site.

From the Products/Services page of the exemplary web site, a user may acquire information on how to use the present invention, as well as the benefits of doing so. Further, the user may access a list of Frequently-Asked Questions (a FAQ) in order to obtain additional information about the web site and the service offered.

From the Subscription page of the web site, a user may choose a service to which he wishes to subscribe, then create a profile to be used in conjunction with the site. The user may also then activate the service by paying for it using a credit card or any other suitable payment method. Credit card payments may be accepted, for example, through Authorize.net, a payment gateway for processing credit cards, or other secured vendors. Verification companies such as Verisign, Thawte, TRUSTe, McAfee, and the like can be utilized to ensure user protection and add legitimacy to the site.

A profile created by a subscriber for use with the present invention may include any of a variety of information that a user or service provider wishes to associate with a subscriber profile. Exemplary fields include name, address, home phone number, cellular phone number, e-mail address, instant messaging IDs, and a password for accessing the system. Other information included in a subscriber profile may include alternate contact information, such as the name of contact individuals, phone numbers, e-mail addresses, and the like. Further, additional contact information with respect to a user's property, pets, children, and the like may also be provided. The present invention is not limited to any precise arrangement or content of subscriber profile.

From the Contact/About page of the web site, the user may access information about the present invention, as well as contact information for a provider implementing the present method. Such contact information may include, but is not limited to, address information, phone number information, e-mail information, and a web form for entering text and submitting the text to the provider implementing the present method.

In addition to the above publicly-accessible pages of the exemplary web site implementing the present invention, a subscriber to the present invention and web site may also access various information screens that are hidden from public view. These information screens may include, for example, a subscriber's subscriber profile, and a listing of member information that a member has chosen to make publicly-accessible.

Subscriber information is preferably maintained in a secure, robust database that is accessible by the subscriber with a paid subscription via the subscriber's User ID and Password. Once accessed, the subscriber can alter the subscriber-specific information in the database. In some aspects of the present invention, a subscriber's subscription package may limit the number of contacts that can be made through the present service within a predetermined time limit. In such implementations, a subscriber can purchase additional contacts by upgrading the subscription package associated with the subscriber's account.

In some implementations of the present invention, an instruction or notification card is also provided to a subscriber to a system implementing the present invention. The card may include information to notify law or emergency personnel of the service provided by the present invention, and also, in some implementations, to create a registry system that may be useful to law enforcement, rescue, and other personnel in the event of a terrorist attack or natural disaster.

As noted above, a subscriber to the present system is provided with a Member ID that identifies that subscriber within the system and allows individuals to contact the subscriber without revealing any of the subscriber's personal information. It is further contemplated that a subscriber may receive one or more ‘throw away’ Member ID numbers for use in, for example, advertising on internet sits like Craig's List®, or for use with online dating sites or in other situations where anonymity is desired with respect to initial contact.

The present invention further provides, in some implementations thereof, an e-mail forwarding service, wherein subscribers receive an e-mail address such as, for example, <Member ID>@MyContact411.com. This allows a user to communicate via e-mail while masking his normal e-mail address, and also allows for continuity if the user changes primary e-mail service providers.

### Examples

Provided below are exemplary implementations of the present invention.

The following examples are meant to demonstrate certain principles of the present invention and are not intended to be limiting.

1. Protecting a Child's Identify and Providing a Safe Communication Route to a Parent

The present invention may be implemented in such as way as to provide a system for protecting the identity of a child and creating a direct link to a parent via, for example, a cell phone. Use of the system allows for protection of a child's identity while still providing a link to contact the child's parents.

Materials for use with the present system may be provided, for example, as part of a kit. Such materials may include tags for book bags, sports bags, and the like, wristbands, or other items that can contain information thereon. The information provided on these tags includes a unique identifier associated with a subscriber of the present system. These tags may also include RFID tags that can be used for tracking or identification of a child carrying a corresponding tag on his or her person.

Use of a subscriber's unique identifier (or other indicia identifying a subscriber of the present system) protects the child's identity because no personally-identifying information is provided on the materials used with the present invention. Thus, predators and others are prevented from obtaining information related to the child's identity. The unique identifier links the child to a parent (subscriber) via the present method without any personally-identifiable information such as name, address, phone number, and the like being located on the child or his possessions. Even if a child is unconscious due to accident or illness, his parents can be reached without the need for personally-identifiable information on the child.

Use of the present method allows a third-party to connect directly with a parent subscriber via the provider, if the subscriber has chosen to allow direct contact. Thus, a third-party with the child in the event of an accident, illness, or other emergency can speak directly to the child's parents, receive information from the parents, and also update the parents with respect to the child's condition, location, and the like. In situations where the parent or other subscriber may be nearby, such as when a child is lost in a shopping center, amusement park, or other area, the present method allows for the parent to be contacted directly and reunite with the child immediately.

The present method also allows for the return of a child's possessions without including personally-identifiable information on the possessions. A third-party finding an item belonging to a child simply contacts the provider and provides the subscriber's unique identifier. The subscriber is then put in contact directly with the third-party, or the provider relays a message to the subscriber concerning the found property. The property can then be returned to the child even though no information allowing identification of the child via name, address, or the like was ever provided to the third-party.

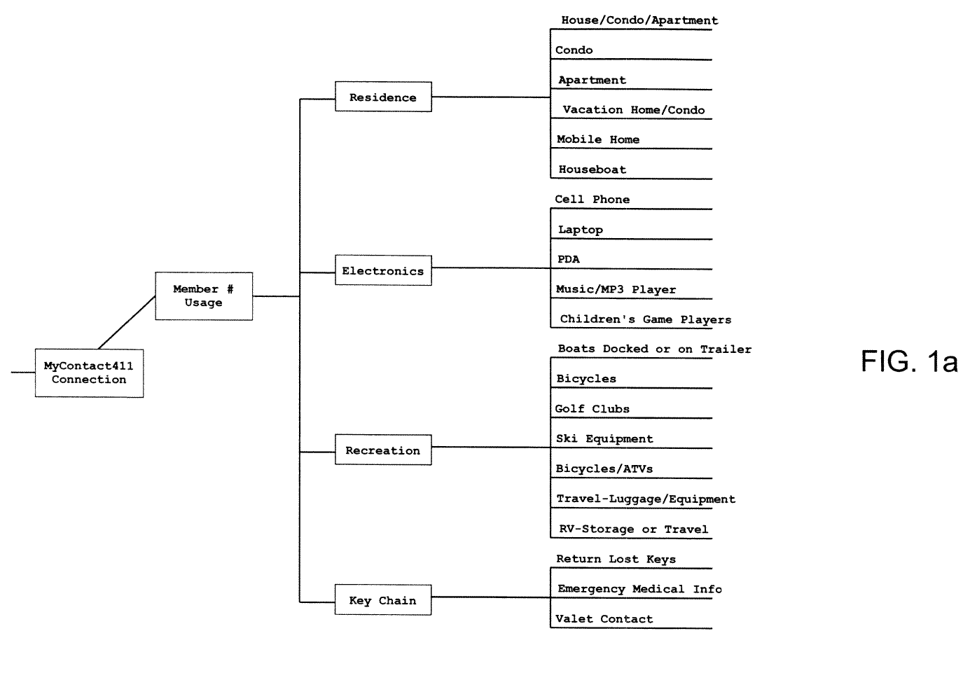

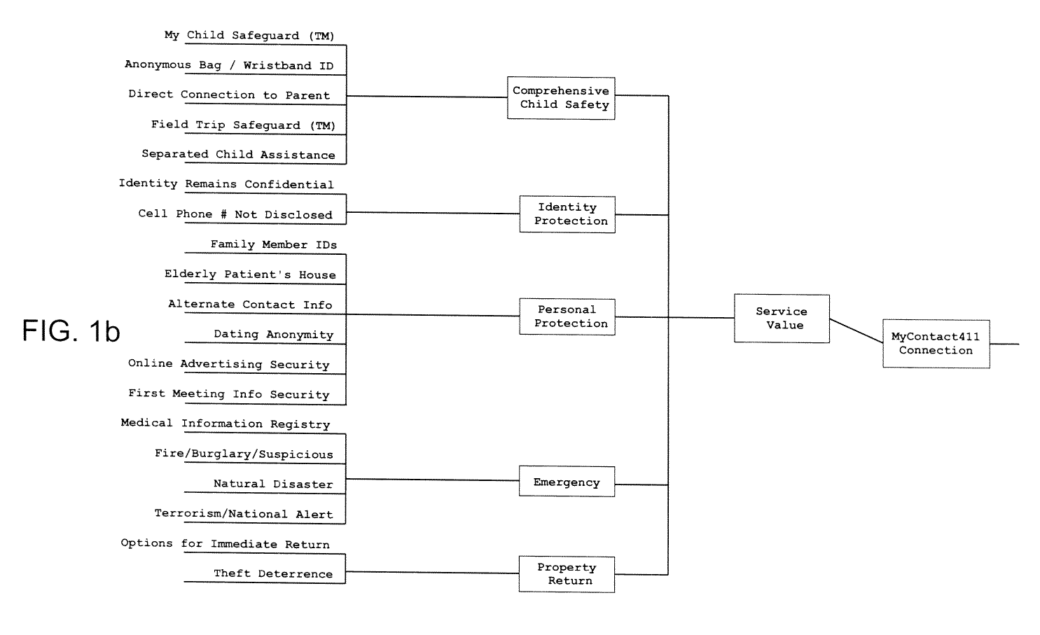

FIG. 1 provides a schematic illustration of aspects of the present invention, specifically the value provided to a subscriber thereof as well as a non-exhaustive list of items on which tags having the subscriber's unique identifier may be used. As shown in the figure, the present invention may be used to provide for comprehensive child safety, identity protection, personal protection, emergency services, and property return. Tags having unique identifiers thereon may be associated with a variety of items, and it is contemplated that in some cases a subscriber's unique identifier may be printed directly on an item being protected.

FIG. 2 provides a schematic of an exemplary web site organization for use by a provider implementing the present method. The boxes in the figure relate to specific screens that may be presented to a user or subscriber while accessing the web site. Included are a home screen, a description of products and services, pricing information, subscription plans, contact information, and hidden information screens that are only available to actual subscribers. The web site design provided in FIG. 2 is exemplary and it is contemplated that a provider implementing the present method may use any suitable web site organization.

2. Protecting a Child while on a Field-Trip or Other Organizational Activity

The present method can also be used to protect a child, as well as a child's possessions, while the child is engaged in an organizational activity, such as a school-related sporting event or field trip, a church field trip, and the like. When used for such purposes, the present method is implemented substantially as described above. In this case, however, the subscriber may be a teacher, field trip leader, church official, chaperone, or an organization itself. For example, an organization may subscribe to a provider of the present method, creating a separate account for a set number of individuals. Then, prior to a field trip or other event, the members of the organization can assign tags to individual children for use on that trip. If any child or her possessions become separated from the group during the trip, the unique identifier associated with that child will allow for the child to be safely returned to the group, or for possessions to be returned. On a subsequent field trip that unique identifier may be associated with another child.

It is further contemplated that kits may be provided in accordance with the present invention, the kits having information instructing a user on how to subscriber to services offered by a provider implementing the present invention, as well as a plurality of tags having thereon a unique identifier for the subscriber and contact information for the provider.

It is to be understood that the above description is intended to be illustrative and not limiting. Many other embodiments and variations of the invention will be apparent to those of skill in the art upon reading this disclosure.

1. A method for providing secure communication between individuals, the method comprising the steps of:
a) assigning to a subscriber of the present method a unique identifier;
b) providing said subscriber at least one tag having said unique identifier indicated thereon, said at least one tag also having indicated thereon contact information for a provider of the present method;
c) receiving from a third party a communication according to the contact information for the provider provided in step b), above;
d) receiving from said third party the subscriber unique identifier provided on said tag;
e) receiving from said third party a message to be transmitted to the subscriber associated with said unique identifier; and
f) transmitting said message to the subscriber associated with the unique identifier provided by the third party.

2. The method according to claim 1, wherein the communication received from the third party in step c) is selected from the group consisting of e-mail messages, telephone calls, cellular phone calls, text messages, and instant messages.

3. The method according to claim 1, wherein the message transmitted to the subscriber in step f) is transmitted via a method selected from the group consisting of e-mail messages, telephone calls, cellular phone calls, text messages, and instant messages.

4. The method according to claim 1, wherein said at least one tag is selected from the group consisting of plastic cards, key chains, decals, dog tags, wristbands, RFID tags, clothing labels, luggage tags, backpack tags, golf-themed tags, ski equipment tags, and house stickers.

5. A method of protecting a child's identity while allowing for secure communication with the child or a guardian of the child, the method comprising the steps of:
a) assigning to a child a unique identifier;
b) providing said child at least one tag having said unique identifier indicated thereon, said at least one tag also having indicated thereon contact information for a provider of the present method;
c) receiving from a third party a communication according to the contact information for the provider provided in step b), above;
d) receiving from said third party the unique identifier provided on said at least one tag;
e) receiving from said third party a message to be transmitted to said child or a guardian of said child; and
f) transmitting said message to said child or a guardian of said child.

6. The method according to claim 5, wherein the communication received from the third party in step c) is selected from the group consisting of e-mail messages, telephone calls, cellular phone calls, text messages, and instant messages.

7. The method according to claim 5, wherein the message transmitted to the child or guardian of the child in step f) is transmitted via a method selected from the group consisting of e-mail messages, telephone calls, cellular phone calls, text messages, and instant messages.

8. The method according to claim 5, wherein said at least one tag is selected from the group consisting of plastic cards, key chains, decals, dog tags, wristbands, RFID tags, clothing labels, luggage tags, backpack tags, sports-themed tags, and ski equipment tags.

9. A kit for allowing confidential communication by a third party with a user of said kit, the kit comprising:
a plurality of tags, the tags having indicated thereon a unique identifier identifying a user of said kit with a provider, the tags further having indicated thereon contact information for said provider,
wherein a third party wishing to communicate with a user of said kit contacts the provider using the contact information provided on at least one of said plurality of tags and relays to the provider the unique identifier and a message for said user.

10. The kit according to claim 9 further comprising instructions for a user wishing to subscribe to a service provided by said provider.
